(19) United States
(12) Patent Application Publication
(10) Pub. No.: US 2016/0070490 A1
(43) Pub. Date: Mar. 10, 2016

(54) STORAGE CONTROL DEVICE AND STORAGE SYSTEM

(71) Applicant: FUJITSU LIMITED, Kawasaki-shi (JP)

(72) Inventors: Hiroshi KOARASHI, Takaoka (JP); Hitomi Akiyama, Kawasaki (JP); Mikio ITO, Kawasaki (JP); kenji higuchi, Kawasaki (JP); MASAAKl SUGIYAMA, Chigasaki (JP); Meiu Naruse, Yokohama (JP); Takeshi Ueda, Kawasaki (JP); REISUKE NAKAGAWA, lnagi (JP)

(73) Assignee: FUJITSU LIMITED, Kawasaki-shi (JP)

(21) Appl. No.: 14/809,720

(22) Filed: Jul. 27, 2015

(30) Foreign Application Priority Data
Sep. 9, 2014 (JP) 2014-182866

(51) Int. Cl. G06F 3/06

(52) U.S. Cl. CPC G06F 3/0619; G06F 3/0689; G06F 3/0665

(57) ABSTRACT

A storage control device includes a processor. The processor is configured to acquire history information on access to multiple logical volumes which are configured using multiple storage devices. The processor is configured to determine from among the multiple logical volumes, on basis of the acquired history information, a preferred logical volume on which restoration processing is preferentially performed. The processor is configured to restore the preferred logical volume stored in a first storage device to be restored among the multiple storage devices into a spare storage device other than the multiple storage devices using restoration data read from the multiple storage devices except for the first storage device.

### CROSS-REFERENCE TO RELATED APPLICATION

This application is based upon and claims the benefit of priority of the prior Japanese Patent Application No. 2014-182866, filed on Sep. 9, 2014, the entire contents of which are incorporated herein by reference.

### FIELD

The embodiment discussed herein is related to a storage control device and a storage system.

### BACKGROUND

With the spread of information and communication technology (ICT) systems, in recent years, a disk array device has been widely used that uses multiple storage devices (hereinafter collectively referred to as a “disk”) represented by hard disk drives (HDDs). In such a disk array device, generally, data security is ensured by recording data on two or more disks in a redundant manner using a redundant arrays of inexpensive disks (RAID) technology.

At this point, RAID refers to a technology that combines multiple disks and manages the combined multiple disks as one virtual disk (RAID group). For RAID levels, there are present RAID 0 to RAID 6 according to an arrangement of pieces of data and data redundancy on each disk.

In a RAID device, data is protected against a failure of disks that make up the RAID by entering parity data into a stripe across multiple disks that make up the RAID. Then, a logical unit number (LUN) is allocated to a logical unit in the RAID, and the logical unit is used in a state where the logical unit is regarded as a disk area by a server.

In a disk array device in which data is made redundant, when a failure occurs in a disk, data stored in the failed disk is reconstructed and thus is stored in a substitute disk such as a spare disk. Generally, such processing is referred to as rebuild processing. Data redundancy is restored by performing the rebuild processing.

Related techniques are disclosed in, for example, Japanese Laid-open Patent Publication No. 10-293658 and Japanese Laid-open Patent Publication No. 2005-78430.

However, in the disk array device in the related art, for example, in a case where multiple LUNs are present in the RAID, because the rebuild processing is performed regardless of importance of the LUNs, in some cases, it takes time to restore a LUN including important data. Furthermore, in a case where a problem occurs in another rebuild source disk while the rebuild processing is in progress, and thus the rebuild processing is interrupted, in some cases, it is difficult to reconstruct the LUN including important data.

### SUMMARY

According to an aspect of the present invention, provided is a storage control device including a processor. The processor is configured to acquire history information on access to multiple logical volumes which are configured using multiple storage devices. The processor is configured to determine from among the multiple logical volumes, on basis of the acquired history information, a preferred logical volume on which restoration processing is preferentially performed. The processor is configured to restore the preferred logical volume stored in a first storage device to be restored among the multiple storage devices into a spare storage device other than the multiple storage devices using restoration data read from the multiple storage devices except for the first storage device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary hardware configuration of a storage system that includes a storage device according to an embodiment;

FIG. 2 is a diagram illustrating an exemplary functional configuration of the storage device according to the embodiment;

FIG. 3 is a diagram illustrating an example of rebuild time information in the storage device according to the embodiment;

FIG. 4 is a diagram illustrating an exemplary configuration of a LUN management table in the storage device according to the embodiment;

FIG. 5 is a diagram for describing rebuild processing in the storage device according to the embodiment;

FIG. 6 is a diagram illustrating an exemplary configuration of access history information in the storage device according to the embodiment;

FIG. 7 is a flowchart illustrating a method of creating access history information in the storage device according to the embodiment;

FIG. 8 is a diagram for describing a first priority assignment method in the storage device according to the embodiment;

FIG. 9 is a diagram for describing a second priority assignment method in the storage device according to the embodiment;

FIG. 10 is a flowchart illustrating rebuild processing in the storage device according to the embodiment;

FIG. 11 is a flowchart illustrating a first priority assignment method in the storage device according to the embodiment;

FIG. 12 is a flowchart illustrating a second priority assignment method in the storage device according to the embodiment; and

FIG. 13 is a flowchart illustrating the rebuild processing performed by a rebuild processing unit in the storage device according to the embodiment.

### DESCRIPTION OF EMBODIMENT

A storage control device and a storage system according to an embodiment will be described below with reference to the accompanying drawings. However, the embodiment described below is only an example, and it is not intended to exclude various modification examples or technology applications that are not specified below. That is, various modifications to the present embodiment may be made in a range that does not depart from the nature thereof. Additionally, it is not intended that each figure includes only constituent elements illustrated in each figure, but may include other functions and the like.

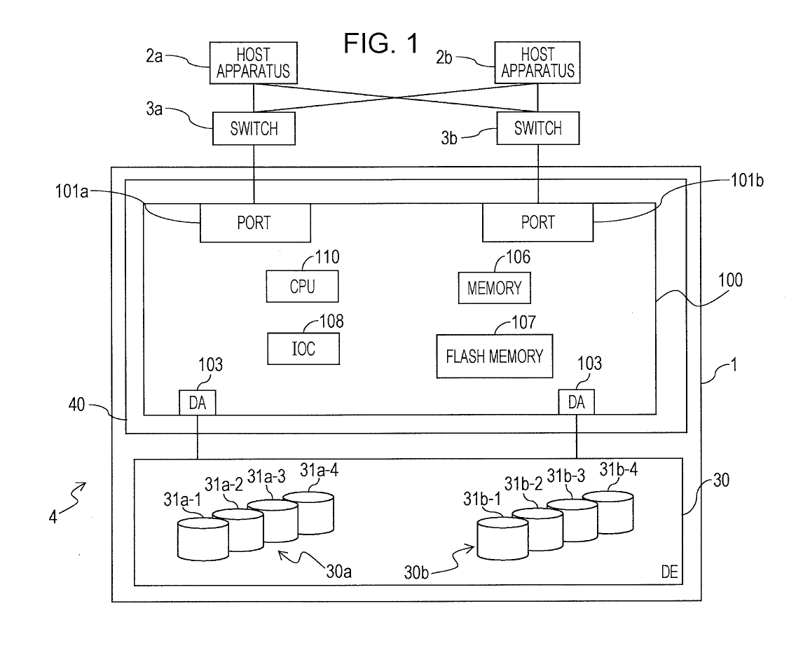

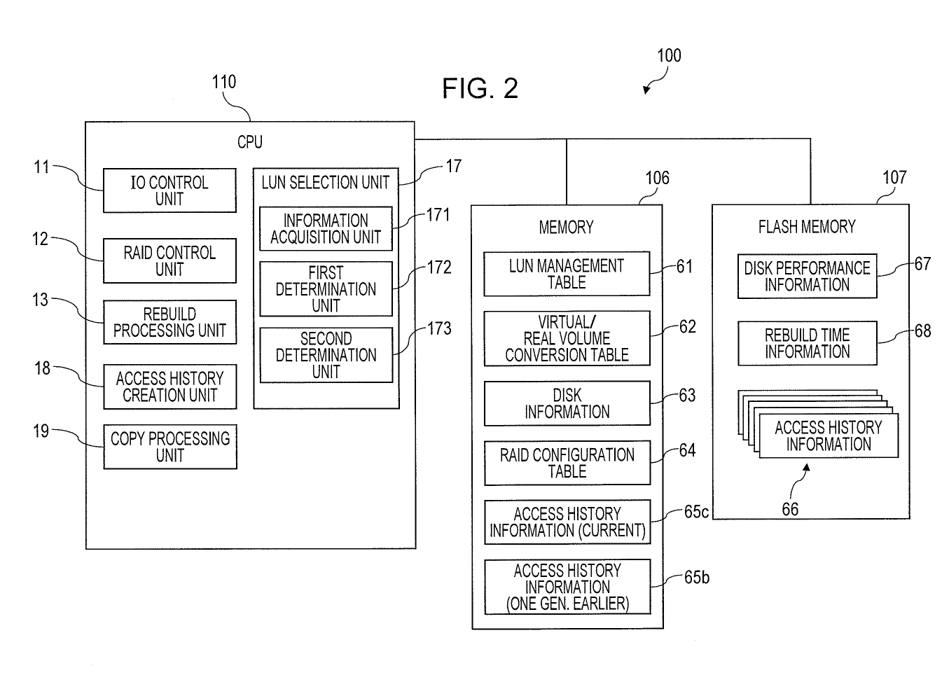

FIG. 1 is a diagram illustrating an exemplary hardware configuration of a storage system 4 that includes a storage device 1 according to the embodiment. FIG. 2 is a diagram illustrating an exemplary functional configuration of the storage device 1 according to the embodiment.

In the storage system 4 that is illustrated in FIG. 1, the storage device 1 and one or more host apparatuses 2a and 2b (FIG. 1 illustrates two host apparatuses) are connected through redundant multiple paths.

The storage device 1 virtualizes storage devices 31 enclosed in a drive enclosure (DE) 30 to create a virtual storage environment. Then, the storage device 1 provides a virtual volume (LUN) to the host apparatuses 2a and 2b that are upper-level apparatuses.

The host apparatuses 2a and 2b, for example, are information processing apparatuses, each of which is, for example, equipped with a server function, and transmits and receives a command of network attached storage (NAS) or of a storage area network (SAN) to and from the storage device 1. These host apparatuses 2a and 2b have similar configurations.

As a reference character indicating a host apparatus, reference characters “2a” and “2b” are used below when desired to specify one among multiple host apparatuses, but a reference character “2” is used below when an arbitrary host apparatus is indicated.

A host apparatus 2 includes a central processing unit (CPU) and a memory that are not illustrated, and performs various functions when the CPU executes an operating system (OS) or a program that is stored in the memory or the like.

The host apparatus 2, for example, writes or reads data to and from a volume that is provided by the storage device 1, by transmitting a disk access command of the NAS, such as a read/write command, to the storage device 1.

Then, in accordance with an input/output request (for example, a read command or a write command) that is made by the host apparatus 2 to a volume, the storage device 1 performs data-reading or data-writing on a real storage that corresponds to the volume. In some cases, the input/output request from the host apparatus 2 is referred to as an “IO command”.

Switches 3a and 3b are relay apparatuses, each of which relays communication between the host apparatuses 2a and 2b and a controller 100 of the storage device 1. The switches 3a and 3b are coupled to the host apparatuses 2a and 2b, and are coupled to the controller 100.

In an example that is illustrated in FIG. 1, the controller 100 includes two ports 101a and 101b. The switch 3a and the switch 3b are coupled to the port 101a and the port 101b, respectively, and the host apparatuses 2a and 2b are coupled to the switches 3a and 3b.

The storage device 1, as illustrated in FIG. 1, includes one or more of the controllers 100 (FIG. 1 illustrates one controller) and one or more of the drive enclosures 30 (FIG. 1 illustrates one drive enclosure).

In the drive enclosure 30, one or more storage devices 31a-1 to 31a-4 and 31b-1 to 31b-4 (physical disks) (FIG. 1 illustrates eight storage devices) are mounted, and storage areas (real volumes and real storages) of these storage devices 31a-1 to 31a-4 and 31b-1 to 31b-4 are provided to the storage device 1.

As a reference character indicating a storage device, reference characters “31a-1” to “31a-4” and “31b-1” to “31b-4” are used below when desired to specify one among multiple storage devices, but a reference character “31” is used below when an arbitrary storage device is indicated. In some cases, the storage device 31 is referred to as a disk 31.

In some cases, the storage devices 31a-1, 31a-2, 31a-3, and 31a-4 are expressed as a disk1, a disk2, a disk3, and a disk4, respectively. What is more, the storage devices 31b-1, 31b-2, 31b-3, and 31b-4 are expressed as a disk1′, a disk2′, a disk3′, and a disk4′, respectively.

The storage device 31 is, for example, a hard disk drive (HDD) or a solid state drive (SSD), and various pieces of data are stored in the storage device 31.

The drive enclosure 30 is configured to include, for example, multiple slots (whose illustration is omitted) and a capacity of the real volume may be changed at any time by inserting the storage device 31 into these slots.

The multiple storage devices 31 provided in the drive enclosure 30 are used to make up a RAID. In the example that is illustrated in FIG. 1, the storage devices 31a-1 to 31a-4 are used to configure a RAID, and the storage devices 31a-1 to 31a-4 configure a RAID group 30a.

In some cases, the storage devices 31a-1 to 31a-4 configuring the RAID group 30a are referred to as RAID constituent disks 31a.

The storage devices 31b-1 to 31b-4 are spare disks that are preliminarily provided for a precaution against a disk failure within the RAID group 30a, and are used as hot spares (HS). These storage devices 31b-1 to 31b-4 configure a spare disk group 30b. In some cases, the storage device 31b is referred to below as a spare disk 31b.

The drive enclosure 30 is coupled to drive adapters (DAs) 103 of the controller 100.

A controller enclosure 40 is provided with one or more of the controllers 100 (FIG. 1 illustrates one controller).

The controller 100 is a storage control device that controls operations within the storage device 1, and performs various types of control, such as control of access to the storage device 31 in the drive enclosure 30 in accordance with the IO command that is transmitted from the host apparatus 2.

In the example that is illustrated in FIG. 1, one controller 100 is provided to the storage device 1, but the number of controllers 100 has no limitation whatsoever. Two or more controllers 100 may be provided to the storage device 1. That is, multiple controllers 100 are made to be redundant. Normally, any one of the controllers 100 may perform, as a primary controller, various types of control, and when the primary controller 100 fails to operate, a secondary controller 100 may take over the operation performed as the primary controller.

The controller 100 is coupled to the host apparatus 2 via the ports 101a and 101b. Then, the controller 100 receives the IO command, such as the read/write command, that is transmitted from the host apparatus 2 and performs control of the storage device 31 via the DAs 103 and the like.

The controller 100, as illustrated in FIG. 1, includes the ports 101a and 101b and multiple DAs 103 (FIG. 1 illustrates two DAs) and includes a CPU 110, a memory 106, a flash memory 107, and an input/output controller (IOC) 108.

As a reference character indicating a port, reference characters “101a” and “101b” are used below when desired to specify one among multiple ports, but a reference character “101” is used below when an arbitrary port is indicated.

The port 101 receives data that is transmitted from the host apparatus 2 and the like, and transmits data that is output from the controller 100, to the host apparatus 2 and the like. That is, the port 101 controls input/output (IO) of data between the controller 100 and an external apparatus such as the host apparatus.

The port 101a is communicably coupled to the host apparatus 2 through the SAN, and is an fibre channel (FC) port, such as an FC interface, provided to a network adapter, for example.

The port 101b is communicably coupled to the host apparatus 2 through the NAS, and, for example, is a network interface card (NIC) port of a local area network (LAN) interface. The controller 100 is coupled to the host apparatus 2 and the like via these ports 101 through a communication line, and receives the IO command and transmits and receives data and the like.

The switch 3a and the switch 3b are coupled to the port 101a and the port 101b, respectively, and the host apparatuses 2a and 2b are coupled to the switches 3a and 3b.

That is, the host apparatuses 2a and 2b are coupled to the port 101a via the switch 3a and to the port 101b via the switch 3b.

In the example that is illustrated in FIG. 1, the controller 100 includes two ports 101a and 101b, but the number of ports has no limitation whatsoever. One, three, or more ports may be included.

The DA 103 is an interface for communicably coupling the controller 100 to the drive enclosure 30 and the storage device 31. The storage device 31 in the drive enclosure 30 is coupled to the DA 103, and the controller 100 performs access control on these storage devices 31 in accordance with the IO command received from the host apparatus 2.

The controller 100 writes and reads data to and from the storage device 31 via these DAs 103. In the example that is illustrated in FIG. 1, two DAs 103 are provided to the controller 100. In the controller 100, the drive enclosure 30 is coupled to each of the DAs 103. Accordingly, the controller 100 may write or read data to and from the storage device 31 in the drive enclosure 30.

The flash memory 107 is a storage device in which a program that is executed by the CPU 110 and various pieces of data are stored.

As illustrated in FIG. 2, disk performance information 67, rebuild time information 68, and an access history database (DB) 66 are stored in the flash memory 107.

The disk performance information 67 is information relating to each of the storage devices 31 provided in the storage device 1. The disk performance information 67 is configured by associating performance information of the storage device 31 to identification information for identifying the storage device 31.

The performance information is information relating to performance of the storage device 31, which has an influence on the time (rebuild time) desired for rebuild processing. The performance information indicates particular performance that has an influence on data access. For example, a data capacity, a motor revolution speed, a RAID type, an interface type such as a serial attached small computer system interface (SAS) and a serial AT attachment (SATA), and a disk type such as an HDD and an SSD.

An information acquisition unit 171 and the like that are described below acquire performance information of a rebuild destination disk 31b and a rebuild source disk 31a with reference to the disk performance information 67.

The rebuild time information 68 indicates the time desired for rebuild processing for the storage device 31.

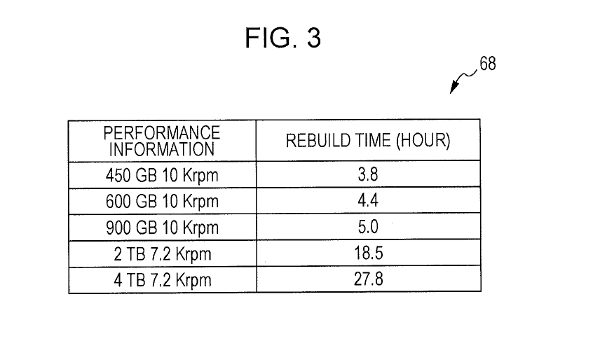

FIG. 3 is a diagram illustrating an example of the rebuild time information 68 in the storage device 1 according to the embodiment.

The rebuild time information 68 that is illustrated in FIG. 3 is configured by associating the time (rebuild time) desired for the rebuild processing to the data capacity and the motor revolution speed that are the pieces of performance information of the storage device 31.

For example, an actual value or an expected value that is based on a performance result is registered in advance in the rebuild time.

The rebuild time information 68 is not limited to this, and for example, may be modified and realized for example, by being associated with the RAID type, the interface type or the disk type that are described above as the performance information.

Based on the performance information of the rebuild destination disk 31b (or a failed disk 31a), a second determination unit 173 that is described below estimates the time desired for the rebuild processing with reference to the rebuild time information 68 and determines a predicted rebuild time.

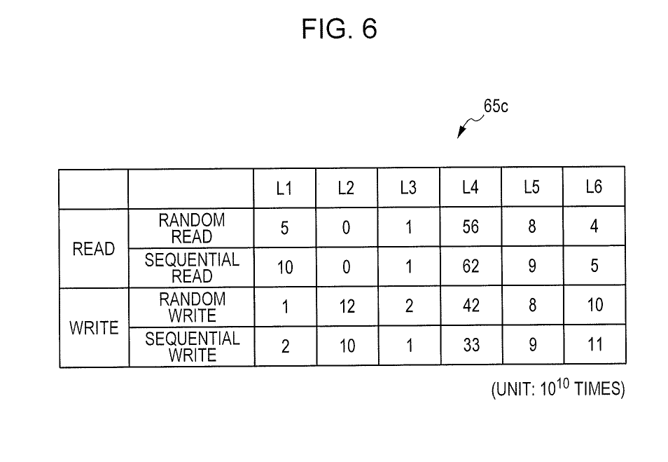

An access history DB 66 is a database for managing access history information 65 (refer to FIG. 6) created by an access history creation unit 18 that is described below. The access history DB 66 records the access history information 65, which is created for every LUN that is included in the storage device 1 and which is an access history for every predetermined time. For example, an access history of an arbitrary LUN for an arbitrary time may be acquired, based on the identification information for identifying the date and time and the LUN, with reference to the access history DB 66.

Furthermore, access history information on a LUN of another storage device that is coupled to the storage system 4 is also recorded in the access history DB 66.

The memory 106 is a storage device in which various pieces of data or programs are temporarily stored, and includes a memory area and a cache area that are not illustrated. Data received from the host apparatus 2 or data that is to be transmitted to the host apparatus 2 are temporarily stored in the cache area. Data or a program is temporarily stored and deployed in the memory area when the CPU 110 executes the program.

Included in the memory 106 is a virtual/real volume conversion table 62, disk information 63, a RAID configuration table 64, and the like that are used for RAID control performed by a RAID control unit 12 that is described below. The virtual/real volume conversion table 62 is a table for mapping an address of the virtual volume that is provided to the host apparatus 2 to a physical address (real address) of the storage device 31.

The disk information 63 is information for managing the storage devices 31 that are included in the storage device 1. In the disk information 63, for example, a disk type of each of the storage devices 31, information as to which slot of the drive enclosure 30 each of the storage devices 31 is mounted to or which storage device 31 is a spare disk 31, or the like is managed.

The RAID configuration table 64 is information that the RAID control unit 12, which is described below, uses to perform RAID management, and for example, a RAID type, information for identifying the storage devices 31a that make up the RAID group 30a, or the like is stored in the RAID configuration table 64.

Because the virtual/real volume conversion table 62, the disk information 63, or the RAID configuration table 64 is already known, detailed descriptions thereof are omitted.

When a rebuild processing unit 13 that is described below performs the rebuild processing, data that is read from each of the rebuild source disks 31a is also temporarily stored in the memory 106.

In addition, a LUN management table 61, and pieces of access history information 65c and 65b are stored in the memory 106. The LUN management table 61 and the pieces of access history information 65c and 65b will be described in detail below. Furthermore, session information that is described below is also stored in the memory 106.

The IOC 108 is a control device that controls data transfer within the controller 100, and for example, realizes direct memory access (DMA) transfer in which data stored in the memory 106 is transferred without the CPU 110 being involved.

The CPU 110 is a processing device that performs various types of control or calculation, and for example, is a multi-core processor (multi-CPU). The CPU 110 realizes various functions by executing an OS or a program that is stored in the flash memory 107 and the like.

As illustrated in FIG. 2, the storage device 1 functions as an IO control unit 11, the RAID control unit 12, the rebuild processing unit 13, a LUN selection unit 17, the access history creation unit 18 and a copy processing unit 19.

Specifically, by executing a program (storage control program), the CPU 110 of the controller 100 serves as the IO control unit 11, the RAID control unit 12, the rebuild processing unit 13, the LUN selection unit 17, the access history creation unit 18, and the copy processing unit 19.

The program (storage control program) for realizing functions of the IO control unit 11, the RAID control unit 12, the rebuild processing unit 13, the LUN selection unit 17, the access history creation unit 18, and the copy processing unit 19 may be provided in a state in which it is recorded on a computer-readable recording medium. The computer-readable recording medium includes, for example, a flexible disk, a compact disc (CD) including a CD-ROM, a CD-R, a CD-RW, or the like, a digital versatile disc (DVD) including a DVD-ROM, a DVD-RAM, a DVD-R, a DVD+R, a DVD-RW, a DVD+RW, a HD DVD, or the like, a blu-ray disk, a magnetic disk, an optical disc, and a magneto-optical disc. A computer reads the program from the recording medium, transfers the read program to an internal storage device or an external storage device for storage, and uses the stored program. The program may be recorded on a storage device (recording medium), for example, such as a magnetic disk, an optical disc, or an optical magnetic disk, and thus may be provided from the storage device to the computer through a communication path.

When the functions of the IO control unit 11, the RAID control unit 12, the rebuild processing unit 13, the LUN selection unit 17, the access history creation unit 18, and the copy processing unit 19 are realized, the program stored in the internal storage device (the flash memory 107 or the memory 106 according to the present embodiment) is executed by a micro processor (the CPU 110 according to the present embodiment) of the computer. At this time, the program recorded in the recording medium may be read and executed by the computer.

The RAID control unit 12 realizes a RAID using the storage devices 31a, and controls the storage devices 31a that make up the RAID. That is, the RAID control unit 12 sets a redundancy configuration using multiple storage devices 31a.

The RAID control unit 12 creates and manages the RAID configuration table 64, sets the RAID group 30a using the RAID constituent disks 31a, and performs various types of RAID control. The RAID management performed by the RAID control unit 12 may be realized with a known technique and thus a description thereof is omitted.

The RAID control unit 12 performs setting and management of the LUN (logical volume) using the storage devices 31, and the host apparatus 2 performs data access on the LUN, which is set. The RAID control unit 12 performs management of the LUN using the LUN management table 61. That is, the RAID control unit 12 includes a function of a LUN management unit that performs management of the LUN.

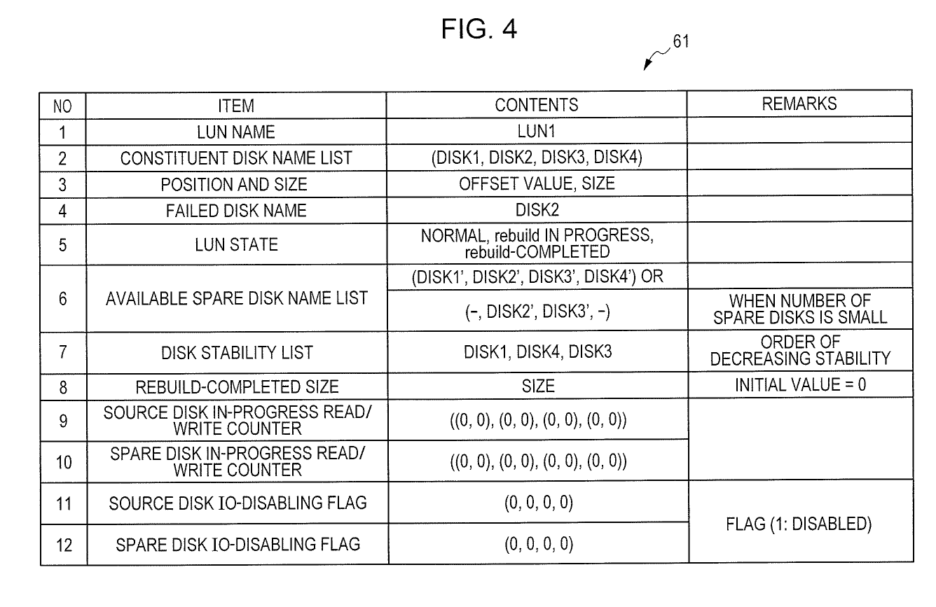

FIG. 4 is a diagram illustrating an exemplary configuration of the LUN management table 61 in the storage device 1 according to the embodiment.

The LUN management table 61 is management information that is provided to every LUN, and the LUN management table 61 that is illustrated in FIG. 4 indicates information on LUN1.

The LUN management table 61 is configured by associating an item, contents, and remarks to one another. In an example that is illustrated in FIG. 4, 12 items are registered in the LUN management table 61, and item numbers No. 1 to No. 12 that identify these items are set.

Specifically, a LUN name, a constituent disk name list, a position and size, a failed disk name, a LUN state, an available spare disk name list, a disk stability list, a rebuild-completed size, a source disk in-progress read/write counter, a spare disk in-progress read/write counter, a source disk IO-disabling flag, and a spare disk IO-disabling flag are registered as the items, and No. 1 to No. 12 (item numbers) are assigned to these items.

Identification information for identifying a LUN is registered under item No. 1 indicating the LUN name, and in the example that is illustrated in FIG. 4, “LUN1” is registered. Information indicating the storage devices 31 that make up the LUN is registered under item No. 2 indicating the constituent disk name list. That is, information indicating the RAID constituent disks 31a is stored in the constituent disk name list. In the example that is illustrated in FIG. 4, disk1, disk2, disk3, and disk4 are registered in the constituent disk name list.

Information indicating a storage position of data in the LUN in the RAID constituent disks 31a that make up the LUN and a size of the data are registered under item No. 3 indicating the position and size. As the position, for example, an offset value is registered.

Information indicating the storage device 31a of which a failure is detected as occurring in the RAID constituent disks 31a that make up the LUN is registered under item No. 4 indicating the failed disk, and as in the example that is illustrated in FIG. 4, “disk2” is registered.

Information indicating a state of the LUN is stored under item No. 5 indicating the LUN state, and in the example that is illustrated in FIG. 4, any one of “normal” indicating a normal state, “rebuild in progress” indicating that the rebuild is in progress, and “rebuild-completed” indicating that the rebuild is completed is stored.

Information indicating the spare disks 31b that are associated with the respective RAID constituent disks 31a is stored under item No. 6 indicating the available spare disk name list.

In the example that is illustrated in FIG. 4, disk1′, disk2′, disk3′ and disk4′ are associated with disk1, disk2, disk3, and disk4 under item No. 2 indicating the constituent disk name list, respectively. That is, disk1 is paired with disk1′, and similarly, disk2, disk3, and disk4, are paired with disk2′, disk3′ and disk4′, respectively.

In a case where the number of available spare disks 31b is smaller than the number of RAID constituent disks 31a, the spare disks 31b are allocated to only some of the RAID constituent disks 31a. In FIG. 4, an example in which the number of the spare disks 31b is small is also illustrated. Only the spare disks 31b that are allocated are indicated, and a portion in which no spare disk 31b is allocated is marked with a dash (“—”).

Information indicating the RAID constituent disks 31a that make up the LUN is registered under item No. 7 indicating the disk stability list, in the order of decreasing stabilities. In the example that is illustrated in FIG. 4, the RAID constituent disks 31a are registered in this order: disk1, disk4, disk3. Because disk2 has failed, disk2 is not registered in the disk stability list.

In a case where the rebuild processing relating to the failed disk under item No. 4 is performed, a sum value (data size) of restored data is registered, as a progress status, under item No. 8 indicating the rebuild-completed size. An initial value of the rebuild-completed size is 0. As the rebuild processing proceeds, the value of the rebuild-completed size increases.

For example, by comparing the size of the LUN under item No. 3, which is described above, and the rebuild-completed size under item No. 8 with each other, it may be determined whether the state of the LUN stored under item No. 5 is “rebuild in progress”, or “rebuild-completed”.

The number of times of in-progress read access and write access to each of the RAID constituent disks 31a (source disks) that make up the LUN is stored under item No. 9 indicating the source disk in-progress read/write counter. That is, a state of IO access to each of the RAID constituent disks 31a is indicated in real time.

In the example that is illustrated in FIG. 4, a value n of an in-progress read counter and a value n of an in-progress write counter for each of the RAID constituent disks 31a are expressed in the form of (n, n).

When the IO command for a LUN-read request or for a LUN-write request is received from the host apparatus 2, for example, the IO control unit 11 that is described below increments a value of the in-progress read counter or of the in-progress write counter for the RAID constituent disk 31a that is an access destination. When the read access or the write access is completed, the IO control unit 11 decrements the value of a corresponding counter.

With reference to the value of the source disk in-progress read/write counter, it may be determined whether or not each of the RAID constituent disks 31a is performing the IO processing.

The number of times of read access and write access that are in progress for each of the spare disks 31b is stored under item No. 10 indicating the spare disk in-progress read/write counter. That is, a state of the IO access to each of the spare disks 31b is indicated.

In the example that is illustrated in FIG. 4, a value n of an in-progress read counter and a value n of an in-progress write counter for each of the spare disks 31b are expressed in the form of (n, n).

For example, when the writing of data to the spare disk 31b is performed, the value of the in-progress write counter is incremented. When the write processing is completed, the value of a corresponding counter is decremented.

With reference to the value of the spare disk in-progress read/write counter, it may be determined whether or not each of the spare disks 31b is performing the IO processing.

Information indicating whether or not the IO processing for each of the RAID constituent disks 31a that make up the LUN is disabled is stored under item No. 11 indicating the source disk IO-disabling flag. In the example that is illustrated in FIG. 4, “0” or “1” is stored. In a case where “1” is set as a flag, this indicates that the IO to the RAID constituent disk 31a is disabled.

Information indicating whether or not the IO processing for each of the spare disks 31b is disabled is stored under item No. 12 indicating the spare disk IO-disabling flag. In the example that is illustrated in FIG. 4, “0” or “1” is stored. In a case where “1” is set as a flag, this indicates that the IO to the spare disk 31b is disabled.

By transferring a copy of data stored in a LUN (copy source LUN) to another LUN (copy destination LUN), the copy processing unit 19 performs data backup.

According to the present embodiment, the copy processing unit 19 performs the data transfer from the copy source LUN to the copy destination LUN, for example, using one point copy (OPC). The OPC is to create a snapshot of data in a predetermined point in time. The snapshot is backup data that does not include an update or the like after the backup. Specifically, when a backup is created, the OPC is a technique of performing backup of all pieces of data in the copy source LUN (volume) which is a target for backup at the point in time for creation.

The technique in which the copy processing unit 19 performs the backup from the copy source LUN to the copy destination LUN is not limited to the OPC, and the backup may be realized using various techniques. For example, the backup may be performed using an extension function of the OPC such as snap OPC, snap OPC+, or quick OPT, or may be performed using other data backup techniques.

The technique of performing the data backup from the copy source LUN to the copy destination LUN using the OPC, the snap OPC, the snap OPC+, or the quick OPC is already known, and thus a detailed description thereof is omitted.

An example in which the copy processing unit 19 performs the data transfer from the copy source LUN to the copy destination LUN using the OPC technique will be described below.

A unit for copy processing such as one-time of the OPC is referred to as a session. In some cases, the processing that copies data from a copy source volume to a copy destination volume is referred to below as a copy session or simply a session.

The copy processing unit 19, for example, manages information relating the copy session using session information (of which an illustration is omitted).

The session information is information relating to the copy session, and for example, includes a session identifier (ID), a copy source LUN and a starting logical block address (LBA), a copy destination LUN and a starting LBA, and a block count (BC) and a copy type. The session information, for example, is stored in a predetermined region of the memory 106. The session information is already known, and a detailed description thereof is omitted.

The information acquisition unit 171 that is described below may obtain information regarding the copy source LUN and the copy destination LUN in the copy session of the OPC with reference to the session information.

In a case where any one of the disks 31a is detected as failing, the rebuild processing unit 13 controls the rebuild processing. In some cases, the disk 31a that is detected as failing is referred to below as the failed disk 31a. The failed disk 31a corresponds to a storage device to be restored. It is determined that, for example, a failure of the disk 31a occurs in a case where a predetermined error such as a medium error occurs a number of times that is equal to or larger than a threshold.

The rebuild processing is processing that automatically restores redundancy of a RAID group, and is processing that rebuilds, when a storage device 31a which belongs the RAID group fails, data of the failed disk 31a using data of storage devices 31a other than the failed disk 31a in the same RAID group into a spare disk 31b (substitute disk, first spare storage device, or restoration destination storage device) that is used as a substitute. In some cases, the storage devices 31a (redundancy storage devices) other than the failed disk 31a in the same RAID group is referred to below as rebuild source disks 31a. In some cases, the rebuild source disks 31a are simply referred to as source disks 31a.

That is, when it is detected that there is a failed disk 31a, the rebuild processing unit 13 rebuilds data of the failed disk 31a on a substitute disk 31b (rebuild destination disk) as a substitute for the failed disk 31a, using data (restoration data) of the rebuild source disks 31a other than the failed disk 31a.

In this manner, the rebuild processing unit 13 functions as a restoration unit that reconfigures (restores) the data of the failed disk 31a into the spare disk (first spare storage device or restoration destination storage device), using redundant data that is read from rebuild source disks 31a (redundancy storage devices) other than the failed disk 31a (storage device to be restored), among the multiple RAID constituent disks 31a.

The restoration of the data of the failed disk 31a by the rebuild processing unit 13 may be realized with an already-known technique.

The multiple storage devices 31a that make up the same RAID group 30a are made to be redundant by the data of each of the storage devices 31a being distributed and copied across other storage devices 31a (redundancy storage devices).

The rebuild processing unit 13 reads the restoration data stored in each of the multiple storage devices 31a (redundancy storage devices) that make up the same RAID group as the failed disk 31a, stores the read restoration data in the substitute disk 31b, and thus restores the data of the failed disk 31a into the substitute disk 31b (data disk build).

For example, the data read from each of the rebuild source disks 31a other than the failed disk 31a is stored in a predetermined area of the memory 106, performs an exclusive OR (XOR) operation with a parity on the data, and thus performs restoration of the data of the failed disk 31a.

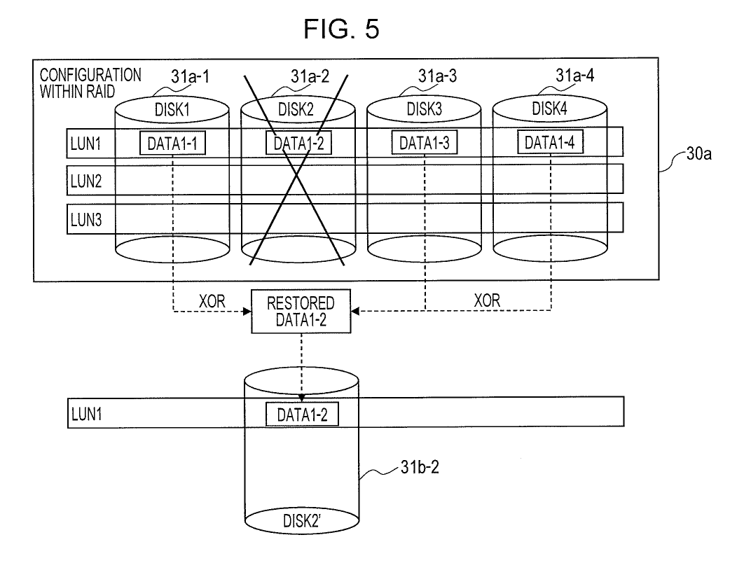

FIG. 5 is a diagram for describing the rebuild processing in the storage device 1 according to the embodiment. In an example that is illustrated in FIG. 5, the RAID group 30a realizes a RAID 5 by 4 (3+1) RAID constituent disks 31a-1 to 31a-4.

In the present embodiment, a case where a failure of the disk 31a-2, among the RAID constituent disks 31a-1 to 31a-4 is detected is described below. That is, it is assumed that the failure of the disk 31a-2 occurs in the RAID group 30a. In some cases, a RAID group 30a in which the failure occurs is referred to below as a failed RAID group 30a.

In the example that is illustrated in FIG. 5, 3 LUNs LUN1 to LUN3 are formed using the disks 31a-1 to 31a-4 of the RAID group 30a, and an example in which, among these, data (data1-2) of the LUN1 is restored is illustrated.

When the failure of the disk 31a-2 is detected, the rebuild processing unit 13 creates data (restored data1-2) of the LUN1 in the failed disk 31a-2, using pieces of restoration data (data1-1, data1-3, and data1-4) of rebuild source disks 31a-1, 31a-3, and 31a-4 within the same RAID group 30a (refer to dashed arrows in FIG. 5).

Then, the data (restored data1-2) of the LUN1 in the failed disk 31a-2, which is created in this manner, is stored in a substitute disk 31b-2 (rebuild destination disk) as a substitute for the failed disk 31a-2. Thus, the data of the LUN1 is restored, and the failed disk 31a-2 is rebuilt.

In a case where multiple LUNs are formed in the RAID group 30a, the rebuild processing unit 13 performs the rebuild processing on every LUN.

In a case where the multiple LUNs are formed in the RAID group 30a, the rebuild processing unit 13 sequentially rebuilds the multiple LUNs in accordance with the order (priority order) that is set by the LUN selection unit 17. That is, the rebuild processing is performed, with high priority, on a LUN (preferred LUN or preferred logical volume) that is selected by the LUN selection unit 17.

In a case where the rebuild processing is performed on the multiple LUNs, the rebuild processing unit 13 manages a progress state of the rebuild processing using a list (of which an illustration is omitted) of the multiple LUNs and a pointer indicating a progress of the rebuild processing in the list.

The access history creation unit 18 collects a history of access to each of the LUNs that are managed by the RAID control unit 12, and creates the access history information 65 (refer to FIG. 6).

Specifically, the access history creation unit 18 counts each of the number of times of the write access and the read access to each of the LUNs using a counter (access counter) that is not illustrated, and records a resulting counter value in the access history information 65c.

FIG. 6 is a diagram illustrating an exemplary configuration of the access history information 65c in the storage device 1 according to the embodiment.

In an example that is illustrated in FIG. 6, the number of times of read access and the number of times of write access that are counted are associated with each of the LUNs L1 to L6 that are managed in the storage device 1. For the read access, the number of times of random read and the number of times of sequential read are managed, and also for the write access, the number of times of random write and the number of times of sequential write are managed.

That is, the access history creation unit 18 manages, using the access history information 65c, the number of times of random read, the number of times of sequential read, the number of times of random write, and the number of times of sequential write. When the read access or the write access to the LUN occurs, the access history creation unit 18 updates a corresponding counter value.

The access history creation unit 18 records the created access history information 65c, along with the date and time information (time stamp) relating to the access history information 65c, in the access history DB 66 of the flash memory 107 every time a predetermined period of time (for example, one hour) elapses.

The date and time information relating to the access history information 65c may be the date and time at which the access history information 65c is created, may be the data and time at which the access history information 65c is recorded in the access history DB 66, and may be variously modified for use.

Accordingly, the access history information 65c that is created for every predetermined period of time is stored as an entry in the access history DB 66, along with information on a point in time at which data is collected.

In some cases, the predetermined period of time, that is, a period of time from when the access history information 65c is previously recorded in the access history DB 66 to when the next access history information 65c is recorded in the access history DB 66, is referred to below as an access history collection period. In the present embodiment, an example in which the access history collection period is one hour is described.

That is, each value of the number of times of random read, the number of times of sequential read, the number of times of random write, and the number of times of sequential write in the access history information 65c is expressed in units of “number of times/one hour”.

The access history creation unit 18 records (copies) the previously created access history information 65c, as access history information 65b, in (to) a predetermined storage area in the memory 106, at the timing when the access history collection period elapses, to be more precise, at the time when the access history information 65c is recorded in the access history DB 66. As a result, the information that is previously recorded as the access history information 65b in the memory 106 is discarded.

That is, in the memory 106, the previously created access history information 65b is overwritten with the access history information 65c for update. In some cases, the overwriting of the access history information 65b with the access history information 65c for update is referred to as updating of the access history information 65b.

After the access history creation unit 18 overwrites the access history information 65b with the access history information 65c for update, the access history creation unit 18 resets the access history information 65c. Thereafter, when access to the LUN occurs, the access history creation unit 18 is updates a corresponding counter value in the access history information 65c which is reset.

That is, the number of times that the read/write access is performed on each of the LUNs during the access history collection period is recorded in the access history information 65c. The access history information 65c indicates a recent history of access to each of the LUNs, and in some cases, the access history information 65c is referred to below as current access history information 65c.

On the other hand, an access history that is collected one piece of access history information earlier, that is, one generation earlier, than the current access history information 65c is recorded in the access history information 65b.

Therefore, the access history for two generations, which corresponds to the current access history information 65c and the one generation earlier access history information 65b, is stored in the memory 106.

The access history information 65c and the access history information 65b have a similar configuration as illustrated in FIG. 6.

The access history information includes the current access history information that is indicated with a reference character “65c” and the access history information that is indicated with a reference character “65b” that is the one generation earlier access history information, but in some cases, access history information is representatively expressed below as access history information 65.

The access history information 65c is recorded in the access history DB 66 in the flash memory 107.

That is, the access history DB 66 is configured as a set of the pieces of access history information 65. Accordingly, the access history DB 66 may be used as statistical information on the access that is performed on the LUN. For example, the second determination unit 173 (rebuild time prediction unit) that is described below may refer to results (access history) of access to an arbitrary LUN during a predetermined period of time, by searching the access history DB 66 using the date and time, the day of the week or the like as keywords.

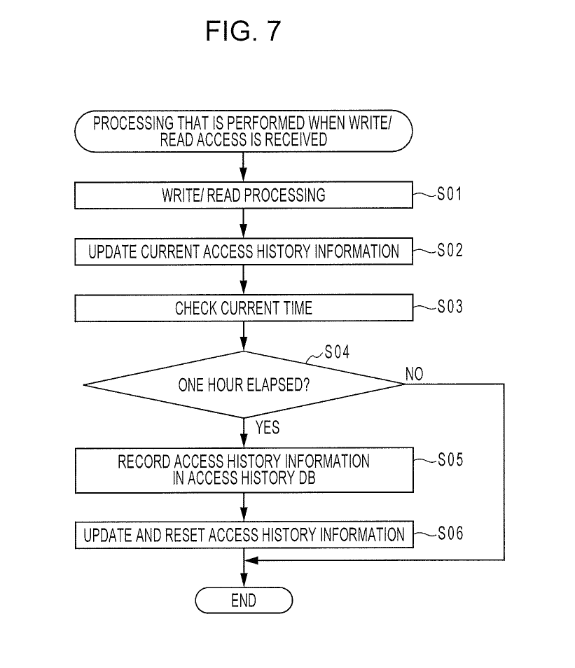

FIG. 7 is a flowchart illustrating a method of creating the access history information 65 in the storage device 1 according to the embodiment.

The processing is performed every time of receiving the write access or the read access to the LUN from the host apparatus 2.

When a request for processing the write access or the read access is received from the host apparatus 2, the IO control unit 11 that is described below performs IO control on the LUN in accordance with the request for the processing (S01).

The access history creation unit 18 updates, in the access history information 65c, a value of a counter that corresponds to the accessed LUN, for a corresponding access type (S02).

The access history creation unit 18 checks “minutes” and “seconds” of the current time (S03) and checks whether or not one hour, that is, an access history collection period has elapsed (S04).

When it is determined that one hour has elapsed (Yes in S04), the current access history information 65c is recorded in the access history DB 66 along with the date and time (S05).

In the memory 106, the access history information 65b is overwritten with the access history information 65c for update, and the access history information 65c is reset (506). Thereafter, the processing ends.

When it is determined that one hour has not elapsed (No in S04), the processing ends.

Based on the access history information 65 created by the access history creation unit 18, the LUN selection unit 17 sets an order (assigns priority) in which the rebuild processing (restoration processing) on multiple LUNs that are formed in the failed RAID group 30a is performed, that is, a rebuild processing order. In some cases, the rebuild processing order is referred to below as a LUN order.

That is, based on the access history information 65 created by the access history creation unit 18, the LUN selection unit 17 determines a preferred LUN on which the rebuild processing is performed preferentially, among the multiple LUNs.

As a method of determining the rebuild processing order, the LUN selection unit 17 is equipped with a first priority assignment method that is performed by a first determination unit 172 (described below) and a second priority assignment method that is performed by the second determination unit 173 (described below).

Selection is made of which of the first priority assignment method and the second priority assignment method is employed, by the user performing input through a graphical user interface (GUI), and a result of the input is recorded, as a setting value, in a predetermined storage area of the flash memory 107 or the like. Which of the first priority assignment method and the second priority assignment method is employed may be registered in advance as setting information.

That is, based on the access history information 65 acquired by the information acquisition unit 171 (access history acquisition unit), the LUN selection unit 17 (the first determination unit 172 and the second determination unit 173) functions as a logical volume determination unit that determines a preferred logical volume on which the restoration processing (rebuild processing) is performed preferentially, among the multiple LUNs that make up the RAID group 30a.

Based on the access history information 65 described above, among multiple LUNs that make up the failed RAID group 30a, the LUN selection unit 17 (the first determination unit 172 and the second determination unit 173) determines a LUN that has a high level of importance, as a preferred LUN.

As illustrated in FIG. 2, the LUN selection unit 17 is equipped with functions of the information acquisition unit 171, the first determination unit 172, and the second determination unit 173.

The information acquisition unit 171 acquires various pieces of information that are used to determine the priority in the rebuild processing that is performed on the LUNs by the first determination unit 172 and the second determination unit 173 that are described below.

For example, when a failure is detected in any one of the RAID constituent disks 31a in the RAID group 30a, the information acquisition unit 171 acquires information on the LUNs that are formed on the failed RAID group 30a.

For example, the information acquisition unit 171 acquires a name of the LUN that is formed on the failed RAID group 30a, with reference to the LUN management table 61. Because the LUN management table 61 is created for every LUN, for example, the LUN that is formed in the RAID group 30a may be recognized with reference to item No. 1 in each LUN management table 61.

The information acquisition unit 171 lists the LUNs that are formed on the failed RAID group 30a, and for example, stores the listed LUNs in a predetermined area of the memory 106.

The information acquisition unit 171 acquires the following information that is used for the first priority assignment method that is performed by the first determination unit 172. In a case where the rebuild processing order is determined based on a level of importance of the LUN, the first priority assignment method is used.

That is, based on each of the LUNs that are listed as described above, the information acquisition unit 171 acquires a relationship in terms of the OPC of each of the LUNs. Specifically, the information acquisition unit 171 checks whether or not each of the listed LUNs is the copy source LUN or the copy destination LUN of the OPC.

In addition, for the LUN that is the copy source of the OPC, the information acquisition unit 171 checks the copy destination LUN with reference to the session information and acquires the access history information 65 relating to the copy destination LUN with reference to the access history DB 66.

The information acquisition unit 171 also acquires the access history information 65 on the LUN, which is neither of the copy source LUN and the copy destination LUN of the OPC, among the listed LUNs which are described above, with reference to the access history DB 66.

The information acquisition unit 171 acquires the following information that is used for the second priority assignment method that is performed by the second determination unit 173. In a case where the storage device 1 determines the rebuild processing order in consideration of a period of time in which the storage device 1 is used, the second priority assignment method is used.

That is, the information acquisition unit 171 collects performance information of each of the storage devices 31 that make up the failed RAID group 30a with reference to the disk performance information 67.

Based on the collected performance information of the storage device 31, the information acquisition unit 171 acquires the rebuild time that is corresponding to the performance information of the storage device 31, with reference to the rebuild time information 68.

The information acquisition unit 171 also acquires the access history information 65 on each of the listed LUNs, which is described above, with reference to the access history DB 66.

The first determination unit 172 determines the LUN order (rebuild processing order) in the rebuild processing on the LUNs using the first priority assignment method.

In the first priority assignment method, the first determination unit 172 sets the rebuild processing order according to the following priority levels.

Priority Level 1: An OPC target LUN (OPC source LUN) having an OPC destination LUN in which the sequential read occurs.

Priority Level 2: An OPC target LUN (OPC source LUN)

Priority Level 3: A LUN that has been accessed a larger number of times during a predetermined period of time before the failure is detected.

Priority Level 4: An OPC destination LUN

(1) Priority Level 1

In the first priority assignment method, the first determination unit 172 determines a LUN which is a copy source of the OPC and the sequential read access occurs in a copy destination LUN thereof, as a LUN that has a high priority in the rebuild processing.

The sequential read access means that consecutive pieces of data are sequentially read for a predetermined threshold number or more.

That is, in the first priority assignment method, the copy source LUN that is configured in a so-called disk-to-disk-to-tape (D2D2T) backup manner is set to have a high priority in the rebuild processing.

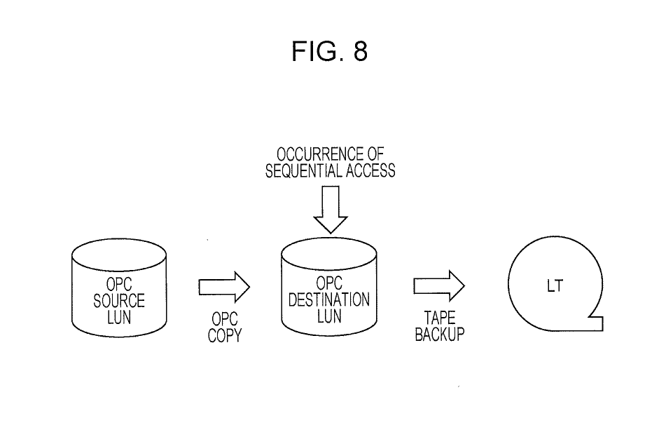

FIG. 8 is a diagram for describing the first priority assignment method that is performed by the first determination unit 172 in the storage device 1 according to the embodiment.

In FIG. 8, the D2D2T configuration is illustrated. That is, data of the copy source LUN (OPC source LUN) is backed up onto the copy destination LUN (OPC destination LUN), and then is further backed up onto a linear tape (LT).

The data that is backed up in two steps in this manner, namely, a LUN (disk drive) backup step and an LT backup step, is considered to be important data to the user. Accordingly, the first determination unit 172 determines that the copy source LUN that is configured to back up in a D2D2T manner has a high priority in the rebuild processing.

In a case where backup copying to the LT is performed, as illustrated in FIG. 8, in order to read the data that is written to the LT, the sequential read access occurs in the copy destination LUN. Accordingly, the first determination unit 172 assigns the highest priority in the rebuild processing to a copy source LUN of the OPC having a copy destination LUN to which the sequential read access occurs.

In a case where there are multiple copy source LUNs of the OPC each having a copy destination LUN to which the sequential read access occurs, priority is also assigned to these multiple preferred LUNs.

For example, for the multiple copy source LUNs, the first determination unit 172 ranks the copy destination LUNs, each of which is the destination of each OPC, in descending order of the number of times of sequential read, and assigns priority to each of the copy source LUNs in accordance with the ranking. To be more precise, the priority is set to be higher to the copy source LUN, where the number of times of sequential read is larger in the OPC copy destination LUN thereof.

According to the embodiment, the first determination unit 172 assigns the highest priority (priority level 1) in the rebuild processing to a copy source LUN of the OPC having a copy destination LUN to which the sequential read access occurs, but priority assignment is not limited to this.

For example, in the OPC target LUN, the priority that is to be assigned to a LUN having an OPC destination to which sequential read occurs at a specific time may be set to be high. Thus, a copy source LUN that has an importance such that a periodical tape backup is performed thereon may be determined with more certainty.

The highest priority in the rebuild processing may be assigned to a copy source LUN of the OPC having a copy destination LUN to which the sequential read access occurs with a frequency larger than a predetermined threshold.

That is, the first determination unit 172 may determine, as the preferred LUN, the copy source LUN which has an OPC destination to which the read (sequential read) occurs the number of times that is equal to or larger than a threshold.

In a case where there are multiple copy source LUNs of the OPC each having a copy destination LUN to which the sequential read access occurs the number of times that is equal to or larger than the threshold, it is also desirable that the priority is set to be higher to the copy source LUN, where the number of times of sequential read is larger in the OPC copy destination LUN thereof.

(2) Priority Level 2

It is assumed that a LUN (copy source LUN) that is not backed up onto the LT, but is backed up with the OPC is data that the user has determined as desired to be backed up at least one time. Accordingly, the first determination unit 172 sets the priority in the rebuild processing, which is to be assigned to a copy source LUN (OPC target LUN) that is not backed up onto the LT but is backed up with the OPC, to be the second highest.

(3) Priority Level 4

On the other hand, it is considered that the OPC destination LUN is a backup destination and is made to be redundant, and it may be determined that the data has a low level of importance. Accordingly, the first determination unit 172 sets the priority in the rebuild processing, which is to be assigned to such an OPC destination LUN, to be the lowest.

(4) Priority Level 3

For LUNs that do not correspond to any one of the priorities 1, 2, and 4, priorities in the rebuild processing are assigned sequentially from a LUN having the highest number of times of access in the access history. For example, with reference to the pieces of access history information 65c and 65b stored in the memory 106, the first determination unit 172 assigns the priority in the rebuild processing to the LUNs in descending order of the number of times of access in these pieces of access history information 65. The number of times of access here, for example, is a sum of the number of times of random read, the number of times of sequential read, the number of times of random write and the number of times of sequential write.

As described above, the history of access for two generations, which is performed during a predetermined period of time before the the point in time when a failure has been detected in the failed disk 31a, is stored in the access history information 65c and 65b that is stored in the memory 106.

That is, based on the access history that is collected during a predetermined period of time (for example, 2 hours) before the time when a failure has been detected in the failed disk 31a, the first determination unit 172 determines a LUN, the number of times of access to which is larger during the predetermined period of time, as the preferred LUN.

The priority that is to be assigned to the LUN may be determined in a short time, by assigning the priority in the rebuild processing on the basis of the access history information 65 that is stored in the memory 106 of which data is accessible at high speed.

With the technique described above, the first determination unit 172 determines the rebuild processing order on the multiple LUNs that are formed on the RAID constituent disk 31a.

The second determination unit 173 determines the order (rebuild processing order) in which to perform the rebuild processing on the LUNs using the second priority assignment method.

In the second priority assignment method, the second determination unit 173 estimates the time desired for the processing for the rebuilding to the rebuild destination disk 31b (restoration destination storage device). Then, the second determination unit 173 predicts a period of time (predicted period of time for rebuild) for which the rebuild of the failed disk 31a (storage device to be restored) is performed by the rebuild processing unit 13.

That is, the second determination unit 173 functions as a restoration period-of-time prediction unit that predicts a period of time in which the rebuild of the failed disk 31a (storage device to be restored) is performed by the rebuild processing unit 13.

Specifically, the second determination unit 173 regards (estimates) the rebuild time, which is acquired by the information acquisition unit 171 from the rebuild time information 68 on the basis of the performance information (specification) of the rebuild destination disk 31b (or the failed disk 31a), as the time (predicted rebuild time) desired for the rebuild to the rebuild destination disk 31b.

Then, the second determination unit 173 determines the predicted period of time for rebuild on the basis of a planned time point of the rebuild start and a predicted rebuild time. That is, the second determination unit 173 determines a period from the planned time point of the rebuild start to a point in time at which the predicted rebuild time elapses, as the predicted period of time for rebuild.

Then, based on the access history DB 66, the second determination unit 173 sets the priority in the processing for the rebuild to each of the LUNs in accordance with the records of access to each of the LUNs during the determined predicted period of time for rebuild, that is, during the same period of time as a period of time from the planned time point of the rebuild start to a predicted time point of the rebuild completion.

Generally, as the rebuild destination disk 31b, a storage device of which a type is the same as that of the failed disk 31a is used. Therefore, according to the present embodiment, it is assumed that the performance information of the rebuild destination disk 31b and the performance information of the failed disk 31a are consistent with each other.

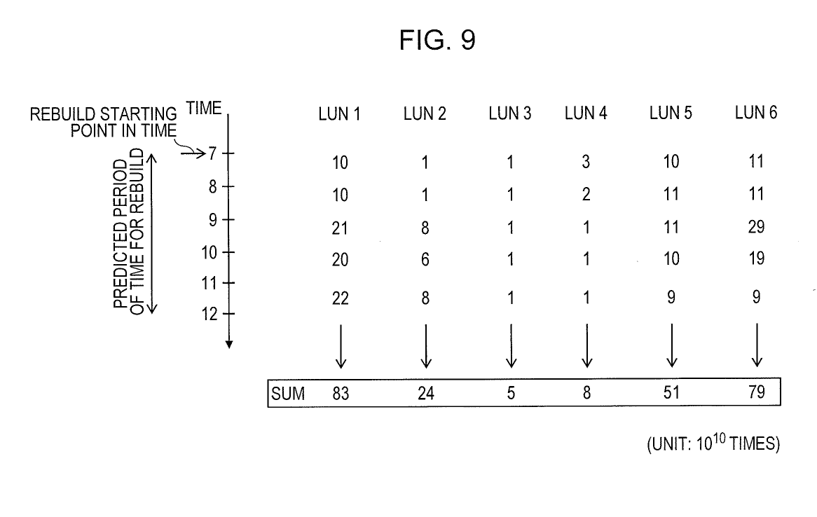

FIG. 9 is a diagram for describing the second priority assignment method that is performed by the second determination unit 173 in the storage device 1 according to the embodiment.

In an example in FIG. 9, a case is illustrated where the rebuild start point in time is 7 o'clock and the second determination unit 173 (restoration prediction unit) predicts that the predicted rebuild time will be 5 hours. In this case, the predicted period of time for rebuild is from 7 o'clock to 12 o'clock.

In the example, a subtotal for the number of times of access to each of the LUNs LUN1 to LUN6 for every hour during a period of time (duration) from 7 o'clock to 12 o'clock is illustrated.

The subtotal for the number of times of access here is a sum of the number of times of random read, the number of times of sequential read, the number of times of random write, and the number of times of sequential write. These values are acquired by the information acquisition unit 171 from the access history DB 66.

For example, at 7 o'clock, a subtotal for the number of times of access to the LUN1 is 10 (unit: 10¹⁰ times), and a subtotal for the number of times of access to the LUN2 is 1 (unit: 10¹⁰ times).

The second determination unit 173 calculates a sum of subtotals for the number of times of access to each of the LUNs during the predicted period of time for rebuild.

For example, in the example in FIG. 9, a sum of subtotals for the number of times of access to the LUN1 for each hour during the period of time from 7 o'clock to 12 o'clock is 83 (unit: 10¹⁰ times) and a sum of subtotals for the number of times of access to the LUN2 for each hour during a period of time from 7 o'clock to 12 o'clock is 24 (unit: 10¹⁰ times). That is, it turns out that statistically, in the storage device 1, the number of times of access during the period of time from 7 o'clock to 12 o'clock, which is the predicted period of time for rebuild, decreases in this order: the LUN1, the LUN6, the LUN5, the LUN2, the LUN4, the LUN3. Therefore, it is considered that there is a high likelihood that during the predicted period of time for rebuild, the access to the LUNs will occur with frequencies in this order: the LUN1, the LUN6, the LUN5, the LUN2, the LUN4, the LUN3.

Accordingly, based on statistical information on the past records of access, the second determination unit 173 sets the LUN, the number of times of access to which is larger during the predicted period of time for rebuild, to have a higher priority in the rebuild processing. Based on the statistical information on the past records of access, the second determination unit 173 ranks the LUNs in such a manner that the rebuild processing is performed in descending order of the number of times of access during the predicted period of time for rebuild.

In the example in FIG. 9, when an arrangement is made in descending order of the sum (statistical information on the past records of access) of subtotals for the number of times of access during the predicted period of time for rebuild, the LUN1, the LUN6, the LUN5, the LUN2, the LUN4, and the LUN3 are arranged in this order. Therefore, the second determination unit 173 sets the rebuild processing order to this order: the LUN1, the LUN6, the LUN5, the LUN2, the LUN4, the LUN3.

Therefore, the rebuild processing is performed most preferentially on the LUN (the LUN1 in the example in FIG. 9), a sum value of the subtotals for the number of times of access to which is largest during the predicted period of time for rebuild, that is, on the LUN, the number of times of access to which is greatest during the predicted period of time for rebuild.

With the technique described above, the second determination unit 173 determines the rebuild processing order on the multiple LUNs that are formed on the RAID constituent disk 31a.

The IO control unit 11 performs IO control on a LUN. The IO control unit 11, for example, performs IO control of a fibre channel protocol (FCP) or of a NAS on the LUN.

The IO control unit 11 performs IO processing on the storage device 31 that is a real volume in accordance with an IO request transmitted from the host apparatus 2, using the virtual/real volume conversion table 62 described above. The IO control unit 11 performs data read or write on the storage devices 31 that make up the LUN, in accordance with the IO request transmitted from the host apparatus 2.

While the rebuild processing by the rebuild processing unit 13 is in progress, when an IO command is issued from the host apparatus 2 to a LUN, the rebuild processing on which is not completed, the IO control unit 11 performs IO processing using a disk data area of the RAID constituent disk 31a in the RAID group 30a.

For example, in a state where the rebuild processing of the data of the LUN2 is not completed, when the read access is performed on the data of the LUN2, the IO control unit 11 performs processing for read from the RAID constituent disk 31a of the RAID group 30a. The read processing on the failed disk 31a-2 is performed by performing an XOR operation with a parity on data of each of the rebuild source disks 31a-1, 31a-3, and 31a-4 (redundancy storage devices) other than the failed disk 31a-2 to perform restoration of data of the failed disk 31a-2.

When a write access is performed on the data of the LUN2, the IO control unit 11 performs write processing on the RAID constituent disk 31a of the RAID group 30a. For the write processing on the failed disk 31a-2, the XOR operation with a parity on the data of each of the rebuild source disks 31a-1, 31a-3, and 31a-4 (redundancy storage devices) other than the failed disk 31a-2 is performed, thus, the restoration of the data of the failed disk 31a-2 is performed. Using the restored data, the write processing is performed on the substitute disk 31b-2 in the spare disk group 30b.

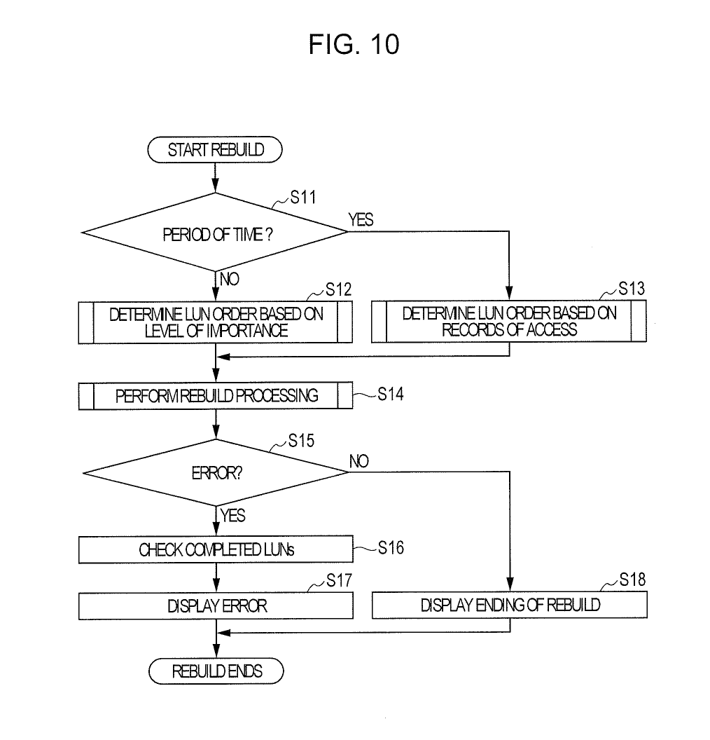

The rebuild processing in the storage device 1 according to the embodiment, which is configured as described above, is described with reference to a flowchart illustrated in FIG. 10.

With reference to a predetermined storage area of the flash memory 107, the LUN selection unit 17 determines which of the first priority assignment method and the second priority assignment method is used as a method of determining the rebuild processing order (S11). For example, it is determined whether or not to determine the rebuild processing order with the second priority assignment method, that is, the rebuild processing considering the period of time in which the storage device 1 is used.

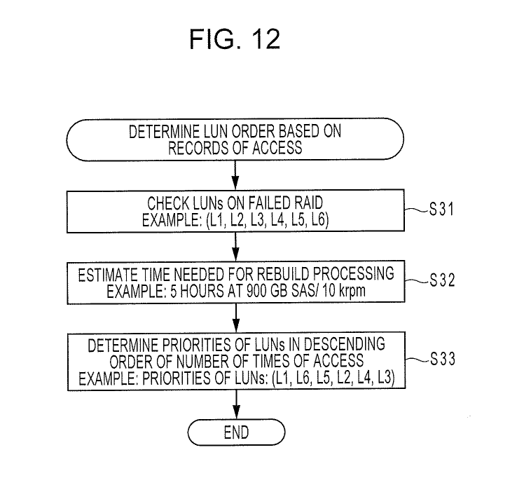

In a case where the rebuild processing order is to be determined with the second priority assignment method, that is, the rebuild processing considering the period of time in which the storage device 1 is used (Yes in S11), processing of determining the rebuild processing order is performed with the second priority assignment method (S13). That is, the LUN order in the rebuild processing is determined based on the data that is used during such a period of time. Specific processing in S13 will be described below with reference to FIG. 12.

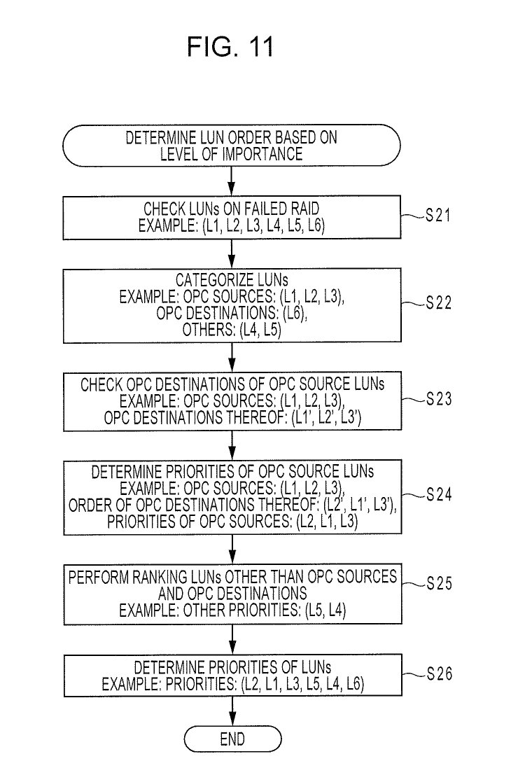

On the other hand, in a case where the rebuild processing order is not to be determined with the second priority assignment method, that is, the rebuild processing considering the period of time in which the storage device 1 is used (No in S11), the processing of determining the rebuild processing order is performed with the first priority assignment method (S12). That is, the LUN order in the rebuild processing is determined based on the level of importance of the LUN. Specific processing in S12 will be described below with reference to FIG. 11.

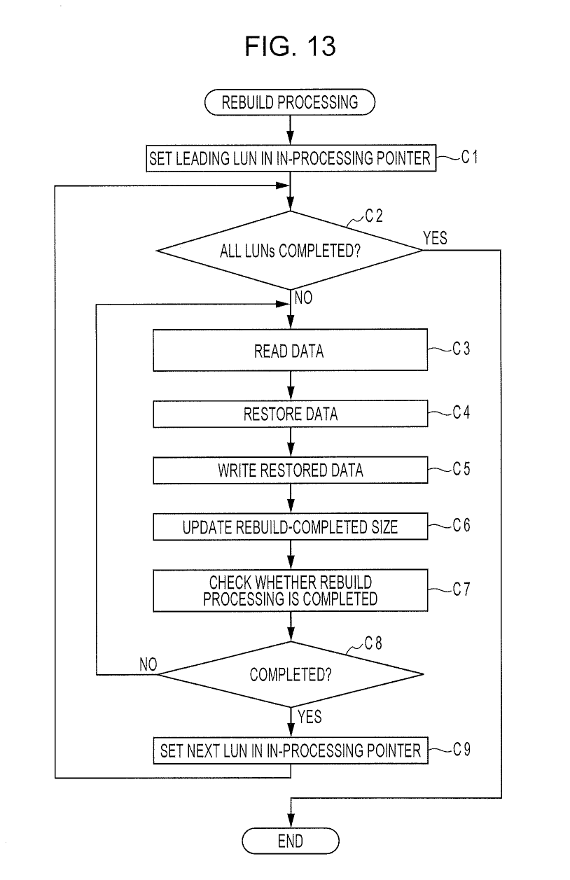

The rebuild processing unit 13 reconstructs the data of the failed disk 31a on the rebuild destination disk 31b (S14). At this time, the rebuild processing unit 13 sequentially reconstructs multiple LUNs, which are included in the failed RAID group 30a, in accordance with the rebuild processing order that is set by the LUN selection unit 17. Specific processing in S14 will be described below with reference to FIG. 13.

The rebuild processing unit 13 checks whether or not an error occurs while the rebuild is in progress (S15). For example, the rebuild processing unit 13 checks any type of failure is detected in the rebuild source disk 31a, and, in a case where a failure is detected while the rebuild processing is in progress in any one of the rebuild source disks 31a, it is determined that an error occurs while the rebuild is in progress. It may be determined whether or not a failure occurs in the rebuild source disks 31a, using an already-known technique, and thus a detailed description thereof is omitted.

In a case where no error occurs while the rebuild processing is in progress (No in S15), the ending of the rebuild processing is displayed on a display or the like of a management terminal that is not illustrated (S18). The ending of the rebuild processing, for example, may be displayed on a display of the host apparatus 2 or the like.

On the other hand, in a case where an error occurs while the rebuild processing is in progress (Yes in S15), the rebuild processing unit 13 checks LUNs on which the rebuild processing has completed (S16). For example, the LUNs (completed LUNs) on which the rebuild processing has completed may be checked with reference to the LUN management table 61 or an in-processing pointer (not illustrated) which indicates a LUN the processing on which is in progress.

Information notifying the completed LUNs is displayed on a display of the management terminal, which is not illustrated, along with the fact that an error occurs while the rebuild processing is in progress (S17), and thus the processing ends. These pieces of information (notification), for example, may be displayed on the display of the host apparatus 2 or the like.

Next, the method (first priority assignment method) of determining, in the storage device 1 according to the embodiment, the rebuild processing order on the basis of the level of importance of the LUN is described with reference to a flowchart illustrated in FIG. 11.

With reference to the LUN management table 61, the information acquisition unit 171 checks the LUNs in the failed RAID group 30a and lists the LUNs that are formed on the failed RAID group 30a (S21).

An example in which the 6 LUNs L1 to L6 are formed in the failed RAID group 30a will be described below.

With reference to the session information, the information acquisition unit 171 checks whether or not each of the listed LUNs is the copy source LUN or the copy destination LUN of the OPC (S22). Then, the information acquisition unit 171 categorizes the LUNs into 3 groups: “OPC sources”, “OPC destinations”, and “others”.

In the example in FIG. 11, L1, L2, and L3 are “OPC sources”, L6 is “OPC destinations”, and L4 and L5 are in “others”.

For each LUN that is in the OPC source group, the information acquisition unit 171 checks the copy destination LUN (OPC destination LUN) with reference to the session information (S23).

In the example in FIG. 11, the OPC destination of the OPC source L1 is L1′, the OPC destination of the OPC source L2 is L2′, and the OPC destination of the OPC source L3 is L3′.

With reference to the access history DB 66, the information acquisition unit 171 acquires the number of times of sequential read from each of the OPC destinations L1′, L2′ and L3′ which are checked in S23.

The first determination unit 172 of the LUN selection unit 17 ranks the OPC destinations L1′ and L2′, and L3′, in descending order of a value of the acquired number of times of sequential read, and sets (ranks) the priorities of the OPC sources L1, L2, and L3 in accordance with the ranking of the OPC destinations L1′ and L2′, and L3′ (S24).

For example, in the OPC destinations L1′, L2′ and L3′, in a case where the number of times of sequential read increases in this order: L2′, L1′, L3′, in accordance with this, priorities of the OPC sources are higher in this order: L2, L1, L3.

Next, the first determination unit 172 assigns priorities to LUNs that are categorized as “others” in S22, that is, to LUNs other than “OPC sources” and “OPC destinations” (S25).

Specifically, with reference to the pieces of access history information 65C and 65b in the memory 106, the first determination unit 172 sets the priorities in the rebuild processing to the LUNs in descending order of the number of times of access.

For example, in L4 and L5 that are categorized as “others”, in a case where the number of times of access to L5 is larger than the number of times of access to L4, priorities of the LUNs are higher in this order: L5, L4.

Thereafter, based on the priorities that are assigned in each of S24 to S25, the first determination unit 172 sets the rebuild processing order on the 6 LUNs L1 to L6 in the failed RAID group 30a (S26).

That is, the rebuild processing order is set on each of the OPC source LUNs which are set in S24, each of the other LUNs which are set in S25, and the OPC destination LUN, in this order.

In a case where multiple LUNs are categorized as “others” in S22, arbitrary priorities may be set for these LUNs, and priorities may be assigned in descending order of the number of times of access with reference to the access history DB 66, and may be assigned in various modified ways.

In the example in FIG. 11, for L1 to L6, the rebuild processing order is set in such a manner that the rebuild processing is performed on L2, L1, L3, L5, L4, and L6 in this order.

Next, a method (second priority assignment method) of determining, in the storage device 1 according to the embodiment, the rebuild processing order in consideration of the period of time in which the storage device 1 is used will be described with reference to a flowchart illustrated in in FIG. 12.

With reference to the LUN management table 61, the information acquisition unit 171 checks the LUNs in the failed RAID group 30a, and lists the LUNs that are formed on the failed RAID group 30a (S31).

An example in which the 6 LUNs L1 to L6 are formed in the failed RAID group 30a will be described below.

The information acquisition unit 171 acquires performance information of the failed disk 31a that is included in the RAID group 30a with reference to the disk performance information 67. The information acquisition unit 171 acquires the rebuild time corresponding to the performance information of the storage device 31 with reference to the rebuild time information 68 on the basis of the acquired performance information of the storage device 31.

Then, the second determination unit 173 estimates, as the predicted rebuild time, the rebuild time that is acquired by the information acquisition unit 171 from the rebuild time information 68 on the basis of the performance information of the failed disk 31a (S32).

In the example in FIG. 12, the f failed disk 31a is set to be “a SAS disk with a disk capacity of 900 GB and with a motor revolution speed of 10 Krpm” and the rebuild time is set to be 5 hours. In this case, the predicted rebuild time is 5 hours.

The second determination unit 173 determines the predicted period of time for rebuild on the basis of the planned time point of the rebuild start and the predicted rebuild time. Then, based on the access history DB 66, the second determination unit 173 sets the priority in the rebuild processing on each of the LUNs in accordance with the records of access to each of the LUNs during the determined predicted period of time for rebuild (S33).

That is, the second determination unit 173 calculates a sum (the statistical information on the past records of access) of subtotals for the number of times of access to each of the LUNs during the predicted period of time for rebuild, and ranks the LUNs in such a manner that the rebuild processing is performed sequentially from a LUN having the highest value of sum of accesses during the predicted period of time for rebuild.

In the example in FIG. 12, the rebuild processing order is set in such a manner that the rebuild processing is performed on L1, L6, L5, L2, L4, and L3 in this order.

Next, the rebuild processing performed by the rebuild processing unit 13 in the storage device 1 according to the embodiment is described with reference to a flowchart illustrated in FIG. 13.

The rebuild processing unit 13 acquires the rebuild processing order that is set by the LUN selection unit 17. The rebuild processing unit 13 also acquires the number of the LUNs with reference to the LUN management table 61. Because the LUN management table 61 is created for every LUN, for example, the number of the LUNs that are formed in the RAID group 30a may be recognized with reference to the number of the LUN management tables 61. The rebuild processing unit 13 stores information indicating a leading LUN (LUN area) according to the rebuild processing order in the in-processing pointer (not illustrated) which indicates the in-processing LUN (C1). The progress state of the rebuild processing may be recognized with reference to the in-processing pointer.

The rebuild processing unit 13 checks the number of non-processing LUNs (C2).

In a case where the number of non-processing LUNs is equal to or larger than 1 (No in C2), based on information on the in-processing LUN, the rebuild processing unit 13 searches each of the survived rebuild source disks 31a, reads data that corresponds to a RAID stripe from the survived rebuild source disk 31a and stores the read data in a predetermined area of the memory 106 (C3).

The rebuild processing unit 13 restores (creation of restored data) data of the failed disk 31a using the data read from each of the rebuild source disks 31a (C4).

The rebuild processing unit 13 writes the restored data to a predetermined position (the same position as in the source) of the spare disk 31b that is assigned to the failed disk 31 (C5).

The rebuild processing unit 13 updates, in the LUN management table 61, the value of the item No. 8 indicating the rebuild-completed size by adding a size of the restored data written in C5 (C6).

The rebuild processing unit 13 checks whether or not the rebuild processing on the in-processing LUN is completed (C7). In a case where the rebuild processing is not completed (No in C8), the processing returns to C3.

On the other hand, in a case where the rebuild processing is completed (Yes in C8), the processing proceeds to C9.

The rebuild processing unit 13 sets, in the LUN management table 61, “rebuild-completed” to the item No. 5 indicating the LUN state. The rebuild processing unit 13 decrements the number of non-processing LUNs and stores information indicating the next LUN according to the rebuild processing order in the in-processing pointer (C9). Thereafter, the processing returns to C2.

In a case where the number of non-processing LUNs is 0 (Yes in C2), the processing ends.

In this manner, in the storage device 1 according to the embodiment, the LUN selection unit 17 sets the order (rebuild processing order) of restoration by the rebuild processing on the LUNs that are formed in the failed RAID group 30a. Then, the rebuild processing unit 13 sequentially reconstructs multiple LUNs, which are included in the failure RAID group 30a, in accordance with the rebuild processing order that is set by the LUN selection unit 17.

As described above, the LUN that is set to have a high priority may be reconstructed earlier, thus resulting great convenience. Even if any problem occurs in the rebuild source disk 31a while the rebuild processing is in progress and completion of the rebuild processing is difficult, there is a high likelihood that the LUN which is set to have a high priority is reconstructed, thus improving reliability.

In the LUN selection unit 17, the first determination unit 172 determines the order of performing the rebuild processing on the basis of the level of importance of the LUN. Thus, a LUN with a high level of importance may be reconstructed early.

For example, the first determination unit 172 may reconstruct earlier the LUN that includes data important to the user, by assigning a high priority in the rebuild processing to the copy source LUN that is configured to backup in a so-called D2D2T manner.

The LUN that includes the data important to the user may also be reconstructed earlier by assigning a higher priority in the rebuild processing to the LUN, the number of times of access to which is larger in the access history.

The second determination unit 173 determines the rebuild processing order in consideration of the period of time in which the storage device 1 is used. That is, the second determination unit 173 estimates the time desired for the processing of the rebuild to the rebuild destination disk 31b (restoration destination storage device) and sets the predicted period of time for rebuild. Then, with reference to the access history DB 66, the second determination unit 173 sets the priority in the rebuild processing on each of the LUNs in accordance with the records of access during the period of time that is the same as the predicted period of time for rebuild.

Thus, the LUN that includes the data important to the user may be reconstructed earlier also by assigning a high priority in the rebuild processing to the LUN, the number of times of access to which is expected to be increased during the predicted period of time for rebuild.

The technology in the disclosure is not limited to the embodiment described above, and various modifications to the embodiment may be made in a range that does not depart from the nature thereof. Each configuration or each processing operation according to the present embodiment may be selected depending on situation, or the configurations and the processing operations may be combined appropriately.

For example, according to the embodiment described above, the example in which the RAID group 30a realizes RAID 5 using the 4 (3+1) RAID constituent disks 31a is described, but embodiments are not limited to this. For example, various modifications, such as RAIDs 2 to 4 or RAID 50 (5+0), RAID 6, and RAID 10 may be made.

According to the embodiment described above, as the rebuild time information 68, the rebuild time is associated with the performance information of the storage device 31, and the second determination unit 173 acquires the rebuild time with reference to the rebuild time information 68 on the basis of the performance information on the storage device 31b that is a rebuild destination, but embodiments are not limited to this. Various modifications to the embodiment may be made.

For example, as the rebuild time information 68, information with which the rebuild time is associated for each storage device 31 may be used. Furthermore, performance (capacity, revolution speed, a RAID type, and the like) of the storage device 31 may be digitized and the rebuild time may be obtained by performing calculation using these numerical values. In this case, the digitized performance information of the storage device 31 or an arithmetic expression functions as the rebuild time information 68.

According to the embodiment described above, the first determination unit 172 assigns the highest priority in the rebuild processing to a copy source LUN of the OPC having a copy destination LUN to which the sequential read access occurs, but the priority assignment is not limited to this. For example, the highest priority in the rebuild processing may be assigned to a copy source LUN of the OPC having a copy destination LUN to which read access other than the sequential read access occurs frequently.

According to the embodiment described above, the access history information 65 for two generations, which corresponds to the access history information 65c and the access history information 65b, is stored in the memory 106, but embodiments are not limited to this. Various modifications to the embodiment may be made.

For example, only the access history information 65c for one generation, that is, the current access history information 65c, may be stored in the memory 106, and the access history information 65 for 3 or more generations, which includes the current access history information 65c, may be stored in the memory 106. The first determination unit 172 sets the priority in the rebuild processing on the basis of the access history information 65 that is stored in the memory 106.

The performance information is not limited to the data capacity, the revolution speed, and the RAID configuration. For example, the performance information may be an interface type, a data transfer speed, or the like of an interface that is included in the storage device 31.

Furthermore, it is possible for the present embodiment to be implemented or manufactured by a person of ordinary skill in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage control device, comprising:
a processor configured to
acquire history information on access to multiple logical volumes which are configured using multiple storage devices,
determine from among the multiple logical volumes, on basis of the acquired history information, a preferred logical volume on which restoration processing is preferentially performed, and
restore the preferred logical volume stored in a first storage device to be restored among the multiple storage devices into a spare storage device other than the multiple storage devices using restoration data read from the multiple storage devices except for the first storage device.

2. The storage control device according to claim 1, wherein
the processor is configured to
determine, as the preferred logical volume, a first logical volume that is determined to have a high level of importance on basis of the history information.

3. The storage control device according to claim 2, wherein
the first logical volume is backed up to a second logical volume, and a read access occurs in the second logical volume.

4. The storage control device according to claim 3, wherein
the read access is a sequential read access.

5. The storage control device according to claim 2, wherein
access to the first logical volume is determined, based on a predetermined condition, to be performed a large number of times during a predetermined period of time before a point of time when a failure is detected in the first storage device.

6. The storage control device according to claim 2, wherein
the processor is configured to
predict a first period of time in which restoration of the first storage device is performed, and
a number of times of access to the first logical volume is determined to be large on basis of the history information during a same period of time as the first period of time.

7. The storage control device according to claim 6, wherein
the processor is configured to
predict the first period of time on basis of restoration time information indicating a time desired for data restoration with regard to each of the multiple storage devices.

8. A storage system, comprising:
multiple storage devices;
a spare storage device other than the multiple storage devices; and
a storage control device including:
a processor configured to
acquire history information on access to multiple logical volumes which are configured using the multiple storage devices,
determine from among the multiple logical volumes, on basis of the acquired history information, a preferred logical volume on which restoration processing is preferentially performed, and
restore the preferred logical volume stored in a first storage device to be restored among the multiple storage devices into the spare storage device using restoration data read from the multiple storage devices except for the first storage device.

9. The storage system according to claim 8, wherein
the processor is configured to
determine, as the preferred logical volume, a first logical volume that is determined to have a high level of importance on basis of the history information.

10. The storage system according to claim 9, wherein
the first logical volume is backed up to a second logical volume, and
a read access occurs in the second logical volume.

11. The storage system according to claim 10, wherein
the read access is a sequential read access.

12. The storage system according to claim 9, wherein
access to the first logical volume is determined, based on a predetermined condition, to be performed a large number of times during a predetermined period of time before a point of time when a failure is detected in the first storage device.

13. The storage system according to claim 9, wherein
the processor is configured to
predict a first period of time in which restoration of the first storage device is performed, and
a number of times of access to the first logical volume is determined to be large on basis of the history information during a same period of time as the first period of time.

14. The storage system according to claim 13, wherein
the processor is configured to
predict the first period of time on basis of restoration time information indicating a time desired for data restoration with regard to each of the multiple storage devices.

15. A computer-readable recording medium having stored therein a program that causes a computer to execute a process, the process comprising:
acquiring history information on access to multiple logical volumes which are configured using multiple storage devices;
determining from among the multiple logical volumes, on basis of the acquired history information, a preferred logical volume on which restoration processing is preferentially performed; and
restoring the preferred logical volume stored in a first storage device to be restored among the multiple storage devices into a spare storage device other than the multiple storage devices using restoration data read from the multiple storage devices except for the first storage device.

16. The computer-readable recording medium according to claim 15, the process further comprising:
determining, as the preferred logical volume, a first logical volume that is determined to have a high level of importance on basis of the history information.

17. The computer-readable recording medium according to claim 16, wherein
the first logical volume is backed up to a second logical volume, and
a read access occurs in the second logical volume.

18. The computer-readable recording medium according to claim 16, wherein
access to the first logical volume is determined, based on a predetermined condition, to be performed a large number of times during a predetermined period of time before a point of time when a failure is detected in the first storage device.

19. The computer-readable recording medium according to claim 16, the process further comprising:
predicting a first period of time in which restoration of the first storage device is performed,
wherein
a number of times of access to the first logical volume is determined to be large on basis of the history information during a same period of time as the first period of time.

20. The computer-readable recording medium according to claim 19, the process further comprising:
predicting the first period of time on basis of restoration time information indicating a time desired for data restoration with regard to each of the multiple storage devices.
